(19) United States
(12) Patent Application Publication
(10) Pub. No.: US 2009/0096978 A1
(43) Pub. Date: Apr. 16, 2009

(54) LIQUID CRYSTAL DISPLAY

(75) Inventor: Jae-hyun KIM, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/173,361

(22) Filed: Jul. 15, 2008

(30) Foreign Application Priority Data
Oct. 16, 2007 (KR) 10-2007-0104117

(51) Int. Cl. G02F 1/1343

(52) U.S. Cl. 349/144

(57) ABSTRACT

A liquid crystal display includes a first substrate, a second substrate facing the first substrate, and a liquid crystal layer disposed between the first substrate and the second substrate. The first substrate includes a pixel electrode having a plurality of sub-pixel electrodes, each sub-pixel electrode defining a domain, and the second substrate includes a common electrode having openings corresponding to the sub-pixel electrodes. Each sub-pixel electrode has a rectangular shape, a maximum of minimum distances between sides of the opening and the corresponding sub-pixel electrode is in the range of about 5 μm to 20 μm, and an area ratio of the openings to the corresponding sub-pixel electrodes is in the range of about 0.12 to 0.2.

### CROSS-REFERENCE TO RELATED APPLICATIONS

This application claims priority from and the benefit of Korean Patent Application No. 10-2007-0104117, filed on Oct. 16, 2007, which is hereby incorporated by reference for all purposes as if fully set forth herein.

### BACKGROUND OF INVENTION

1. Field of the Invention

The present invention relates to a liquid crystal display.

2. Discussion of the Background

A liquid crystal display (LCD) includes a first substrate on which thin film transistors (TFTs) are disposed, a second substrate facing the first substrate, and a liquid crystal layer disposed therebetween. The alignment of liquid crystal molecules in the liquid crystal layer varies according to electric fields formed between pixel electrodes and a common electrode, thereby adjusting light transmittance.

LCDs are used as display units in various kinds of electronic devices. Because electronic devices, in particular mobile devices such as cellular phones, are often required to be slim, a protection window disposed on the outside of the LCD may either be thin or omitted. Thus, when a user applies pressure to the LCD with a pen or the like, the substrate may deform. The deformation of the substrate may cause broken liquid crystal texture, which may create recognizable blurs, generally referred to as bruising. That is, when the LCD is drawn on with a pen, the trace remains along the drawing direction for a period of time.

The bruising may be more serious in an LCD that has a weak electric field.

### SUMMARY OF INVENTION

The present invention discloses a liquid crystal display including a first substrate, a second substrate facing the first substrate, and a liquid crystal layer disposed between the first substrate and the second substrate. The first substrate includes a pixel electrode having a plurality of sub-pixel electrodes, each sub-pixel electrode defining a domain, and the second substrate includes a common electrode having openings corresponding to the sub-pixel electrodes. Each sub-pixel electrode has a rectangular shape, a maximum of minimum distances between sides of the opening and the corresponding sub-pixel electrode is in the range of about 5 μm to 20 μm, and an area ratio of the openings to the corresponding sub-pixel electrodes is in the range of about 0.12 to 0.2.

The present invention also discloses a liquid crystal display including a first substrate, a second substrate facing the first substrate, and a liquid crystal layer disposed between the first substrate and the second substrate. The first substrate includes a pixel electrode having a plurality of sub-pixel electrodes, each sub-pixel electrode defining a domain, and the second substrate includes a common electrode having openings corresponding to the sub-pixel electrodes. The distance between one side of each sub-pixel electrode and one side of the corresponding opening, the side of the sub-pixel electrode being parallel with the side of the corresponding opening, is in the range of about 5 μm to 20 μm, and each opening extends lengthwise and has a width of about 14 μm or more.

The present invention also discloses a liquid crystal display including a first substrate, a second substrate facing the first substrate, and a liquid crystal layer disposed between the first substrate and the second substrate. The first substrate includes a pixel electrode having a plurality of sub-pixel electrodes to define a domain, and the second substrate includes a common electrode having openings corresponding to the sub-pixel electrodes. An area ratio of the openings to the corresponding sub-pixel electrodes is in the range of about 0.12 to 0.2, and the opening extends lengthwise and has a width of about 14 μm or more.

It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an arrangement view of an LCD according to a first exemplary embodiment of the present invention.

FIG. 2 is a cross-sectional view of the LCD taken along line II-II in FIG. 1.

FIG. 3 is a cross-sectional view of the LCD taken along line III-III in FIG. 1.

FIG. 4 is an arrangement view of a sub-pixel electrode and an opening in the LCD according to the first exemplary embodiment of the present invention.

FIG. 5 is another arrangement view of the sub-pixel electrode and the opening in the LCD according to the first exemplary embodiment of the present invention.

FIG. 6 is a cross-sectional view of an LCD according to a second exemplary embodiment of the present invention.

FIG. 7 is an arrangement view of an LCD according to a third exemplary embodiment of the present invention.

FIG. 8 is an arrangement view of a sub-pixel electrode and an opening in an LCD according to a fourth exemplary embodiment of the present invention.

### DETAILED DESCRIPTION OF ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

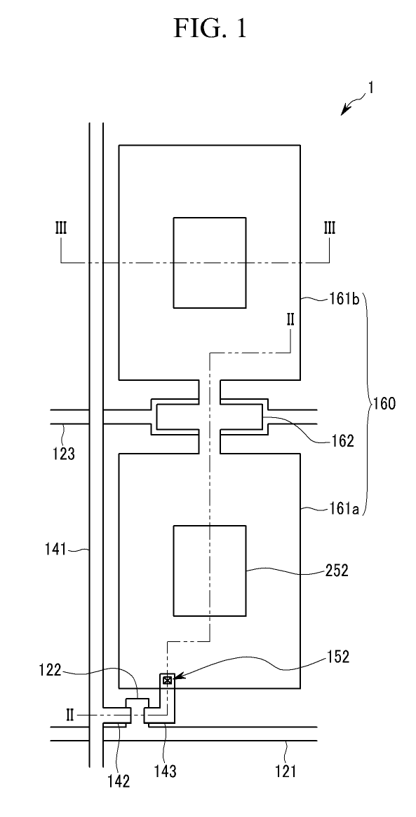

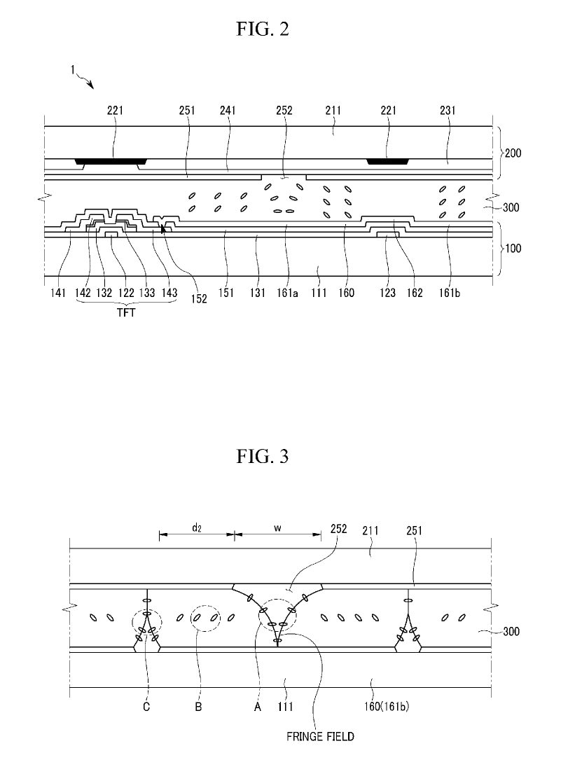

Hereinafter, an LCD according to a first exemplary embodiment of the present invention will be described with reference to FIG. 1 and FIG. 2. FIG. 1 shows only a single pixel without neighboring pixels.

Referring to FIG. 2, an LCD 1 includes a first substrate 100, a second substrate 200 facing the first substrate 100, and a liquid crystal layer 300 disposed between the substrates 100 and 200.

First, the first substrate 100 will be described.

A gate wiring is disposed on a first insulating substrate 111, which may be made of an insulating material such as glass, plastic, or quartz. The gate wiring may be made of a single metal layer or multiple metal layers. The gate wiring includes a plurality of gate lines 121 extending transversely, a plurality of gate electrodes 122 connected to the gate lines 121, and a plurality of storage electrode lines 123 extending parallel with the gate lines 121 and passing through the center of each pixel.

A gate insulating layer 131 made of silicon nitride (SiNx) or the like is disposed on the first insulating substrate 111 to cover the gate wiring.

A semiconductor layer 132 made of amorphous silicon is disposed on the gate insulating layer 131 over the gate electrodes 122. An ohmic contact layer 133, which may be made of hydrogenated amorphous silicon highly doped with n-type impurities, is disposed on the semiconductor layer 132.

A data wiring is disposed on the ohmic contact layer 133 and the gate insulating layer 131. The data wiring may be made of a single metal layer or multiple metal layers. The data wiring includes a plurality of data lines 141 formed lengthwise to cross the gate lines 121, a plurality of source electrodes 142 branched from the data lines 141 and extended over the ohmic contact layer 133, a plurality of drain electrodes 143 spaced apart from the source electrodes 142 and disposed on portions of the ohmic contact layer 133 opposite to the source electrodes 142.

The ohmic contact layer 133 is not disposed in channel areas between a plurality of source electrodes 142 and a plurality of drain electrodes 143.

A passivation layer 151 is disposed on the data wiring and portions of the semiconductor layer 132 not covered with the data wiring. The passivation layer 151 is disposed with a plurality of contact holes 152 to expose portions of the drain electrodes 143.

A plurality of pixel electrodes 160 are disposed on the passivation layer 151 and connected to the drain electrodes 143 through the contact holes 152. The pixel electrodes 160 may be made of a transparent conductive material, such as indium tin oxide (ITO) or indium zinc oxide (IZO).

Each of the pixel electrode 160 includes a first sub-pixel electrode 161a, a second sub-pixel electrode 161b, and a storage capacity forming part 162 disposed between the first and second sub-pixel electrodes 161a and 161b. The first and second sub-pixel electrodes 161a and 161b are disposed in an extending direction of the data lines 141, i.e., lengthwise. The first and second sub-pixel electrodes 161a and 161b and the storage capacity forming part 162 may be formed integrally and applied with the same electric signal, i.e., a pixel voltage, through the corresponding drain electrode 143.

Each pixel electrode 160 has a rectangular shape, which has a width to length ratio of approximately 1:3, and is extended lengthwise. Each sub-pixel electrode 161a and 161b also has a rectangular shape, in which the length is longer than the width, and is extended lengthwise. However, the respective sub-pixel electrodes 161a and 161b have a smaller width to length ratio than the respective pixel electrode 160. The sub-pixel electrodes 161a and 161b are described below in detail.

Each storage capacity forming part 162 has a portion in which the width is expanded to overlap a portion of the corresponding storage electrode line 123, and a storage capacity is formed in the gate insulating layer 131 and the passivation layer 151 disposed between the expanded width portion of the storage capacity forming part 162 and the storage electrode line 123.

A TFT of the aforementioned first substrate 100 is a bottom-gate type having the semiconductor layer 132 of amorphous silicon. Alternatively, the TFTs may be a top-gate type where the gate electrodes 122 are disposed on the semiconductor layer 132, or the semiconductor layer 132 may be made of polycrystalline silicon.

Next, the second substrate 200 will be described.

A black matrix 221 is disposed on a second insulating substrate 211, which may be made of an insulating material such as glass, plastic, or quartz. The black matrix 221 may be made of a photoresist organic material including a black pigment. The black pigment may be carbon black or the like. The black matrix 221 prevents external light from reaching the TFTs on the first substrate 100. The black matrix 221 is also disposed on the storage electrode lines 123.

A color filter layer 231 is disposed on the second insulating substrate 211 and the black matrix 221. The color filter layer 231 may include sub-layers with different colors, e.g., red, green, and blue.

An overcoat layer 241 is disposed on the color filter layer 231. The overcoat layer 241 provides a planar surface. The overcoat layer 241 may be omitted.

A common electrode 251 is disposed on the overcoat layer 241. The common electrode 251 may be made of a transparent conductive material, such as ITO or IZO. The common electrode 251 applies a voltage to the liquid crystal layer 300 along with the pixel electrodes 160 of the first substrate 100.

The common electrode 251 is disposed over the entire second substrate 200 and includes a plurality of openings 252 in areas corresponding to the sub-pixel electrodes 161a and 161b of the first substrate 100. Each opening 252 is positioned nearly in the center area of the corresponding sub-pixel electrode 161a or 161b and has a rectangular shape in which the length in the extending direction of the data lines 141 is longer than the width.

In the present exemplary embodiment, each sub-pixel electrode 161a or 161b have a similar width to length ratio to the corresponding opening 252.

Alternatively, the corresponding opening 252 may have a higher width to length ratio than each sub-pixel electrode 161a and 161b. For example, the opening 252 may have a width to length ratio that is in the range of about 0.2 to 1.7 higher than that of the sub-pixel electrode 161a or 161b. In detail, the sub-pixel electrode 161a or 161b may have a width to length ratio in the range of about 1.3 to 1.7, and the opening 252 may have a width to length ratio in the range of about 1.5 to 3.

As described above, the liquid crystal layer 300 is disposed between the first substrate 100 and the second substrate 200. The liquid crystal layer 300 is in a vertical alignment (VA) mode having negative dielectric anisotropy, where liquid crystal molecules are aligned perpendicular to the substrates 100 and 200 in a lengthwise direction in a voltage-off state.

The liquid crystal molecules with the negative dielectric anisotropy are oriented perpendicularly to an electric field in a voltage-on state. The liquid crystal molecules in the liquid crystal layer 300 tilt toward the opening 252 corresponding to each sub-pixel electrode 161a or 161b, thereby forming a domain. One pixel electrode 160 includes two domains, and thus visibility is enhanced.

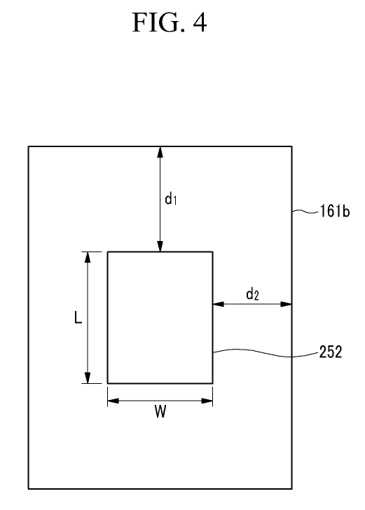

In the following, the relation of the sub-pixel electrodes 161a and 161b and the openings 252 will be described with reference to FIG. 3 and FIG. 4.

FIG. 3 is a cross-sectional view taken along line III-III in FIG. 1, showing a pixel electrode 160 in a neighboring pixel of that shown in FIG. 1.

FIG. 4 only shows the second sub-pixel electrode 161b and the corresponding opening 252. The description with reference to FIG. 3 and FIG. 4 will be equally applicable to the first sub-pixel electrode 161a and the corresponding opening 252. Also, FIG. 3 shows a cross section in the transverse direction parallel with the gate line 121, but the description with reference to FIG. 3 will be equally applicable to a cross section in the longitudinal direction parallel with the data line 141.

First, the size of the opening 252 will be described.

Liquid crystal molecules of the liquid crystal layer 300 positioned in area A of FIG. 3 are influenced mainly by a fringe field of end parts of the opening 252. Liquid crystal molecules of the liquid crystal layer 300 positioned in area B are influenced by a fringe field of the opening 252 to be oriented at an initial orientation angle. The orientation direction of the liquid crystal molecules in area B is determined according to the initial orientation angle when an electric field is formed. Controlling light transmittance is achieved by adjusting the orientation of the liquid crystal molecules of the liquid crystal layer 300 in area B.

When the width W of the opening 252 is small, the fringe field is strong, so liquid crystal molecules around the opening 252 move in the vertical direction. Here, liquid crystal molecules in the narrow opening 252 collide and then twist to decrease the total free energy. The twisting extends the time required for re-alignment of liquid crystal molecules when a liquid crystal director is distorted by outside pressure, thereby generating bruising.

When the opening 252 is used to form a domain, as in the present exemplary embodiment, liquid crystals spread out from the opening 252 and the electric field is weak so that re-alignment of liquid crystal molecules may be slow as compared to a twisted nematic (TN) mode, and thus bruising may be even worse.

On the other hand, when the width W of the opening 252 is large, the influence of the fringe field is relatively weak. Further, as the opening 252 is comparatively wide, the twisting of liquid crystal molecules in the opening 252 decreases. Accordingly, re-alignment of the liquid crystal molecules become simpler when a liquid crystal director is distorted by outside pressure, and thus bruising may be decreased.

Thus, the width W of the opening 252 may be increased to reduce bruising. In the opening 252, the length L is longer than the width W.

When the width W of the opening 252 is increased, the area of the opening 252 is also increased. Liquid crystal molecules of the liquid crystal layer 300 in area A, which corresponds to the opening 252, may not be sufficiently controlled when the opening 252 is bigger, and therefore light transmittance may be decreased. That is, when the opening 252 is expanded, bruising may be decreased but light transmittance may also be reduced. On the contrary, when the opening 252 is narrowed, bruising may be increased but light transmittance may be improved.

Additionally, when an area ratio of the opening 252 to the second sub-pixel electrode 161b is increased, the LCD 1 may become vulnerable to static electricity during a process of adhering a polarizing plate or the like. Thus, the area ratio of the opening 252 to the second sub-pixel electrode 161b should be limited.

As described above, the area of the opening 252 should be determined in consideration of bruising, transmittance, and static electricity, and also the area of the second sub-pixel electrode 161b.

An experimental result reveals that the opening 252 should have a width W of about 14 μm or more to efficiently decrease bruising. Here, the opening 252 should have a length L of about 14 μm or more.

Further, the result shows that the area ratio of the opening 252 to the second sub-pixel electrode 161b should be in the range of about 0.12 to 0.2 to minimize a reduction in transmittance and to decrease static electricity. When the width W of the opening 252 is increased excessively, transmittance may be reduced. The width W of the opening 252 is restricted by the area ratio of the opening 252 to the second sub-pixel electrode 161b. In detail, the width W of the opening 252 may be limited to about 30 μm or less.

The LCD 1 according to the present exemplary embodiment may be employed for a small or medium display device with a resolution of about 120 ppi (pixel per inch) or more. In the case of a comparatively large display device with a resolution of about 120 ppi to 180 ppi, when the area of the opening 252 is slightly increased, transmittance may not be significantly decreased. Thus, in a display device with a resolution of about 120 ppi to 180 ppi, the area ratio of the opening 252 to the second sub-pixel electrode 161b may be in the range of about 0.14 to 0.2.

Next, the distances d1 and d2 between the edges of the second sub-pixel electrode 161b and the opening 252 will be described below.

When the texture of the liquid crystal layer 300 is destroyed by outside pressure, liquid crystal molecules of the liquid crystal layer 300 are sequentially realigned to dissolve bruising starting with liquid crystal molecules in area C positioned on the edge of the second sub-pixel electrode 161b and going toward the liquid crystal molecules of the liquid crystal layer 300 in area B. However, when the distances d1 and d2 are great, the re-alignment may be delayed such that bruising occurs.

Short distances d1 and d2 are favorable to the reduction of bruising. It has been found that bruising is remarkably reduced when the distances d1 and d2 are about 20 μm or less. On the other hand, when the distances d1 and d2 are too short, area B becomes small so that transmittance gets worse. Thus, the distances d1 and d2 may be more than about 5 μm.

As for the forms of the second sub-pixel electrode 161b and the opening 252 and the arrangements thereof, the distance d1 in the longitudinal direction should belonger than the distance d2 in the transverse direction. Thus, when the distance d1 is less than about 20 μm, the distance d2 should be less than about 20 μm.

When the opening 252 is expanded to decrease bruising, a fringe field around the opening 252 is weakened to lower a response speed. When the distances d1 and d2 are short, lowered response speed is compensated.

In the foregoing description, the second sub-pixel electrode 161b and the opening 252 have a complete rectangular shape, but a rectangular shape according to exemplary embodiments of the present invention includes a roughly rectangular shape with slight modifications, such as round corners or the like.

The opening 252 may be positioned slightly out of the center area of the second sub-pixel electrode 161b. In this case, the maximum of minimum distances from each side of the second sub-pixel electrode 161b to the opening 252 may be about 20 μm or less.

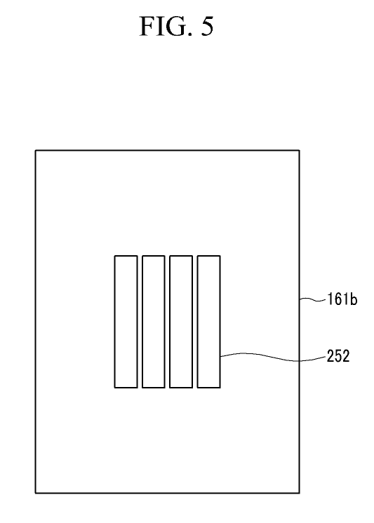

FIG. 5 shows another form of an opening 252 in the LCD according to the first exemplary embodiment.

A plurality of openings 252 that extend lengthwise may be provided. Alternatively, a plurality of openings 252 that extend transversely may be provided. The openings 252 are not limited to the foregoing shape and may be modified to have various shapes, such as a circle, an oval, etc.

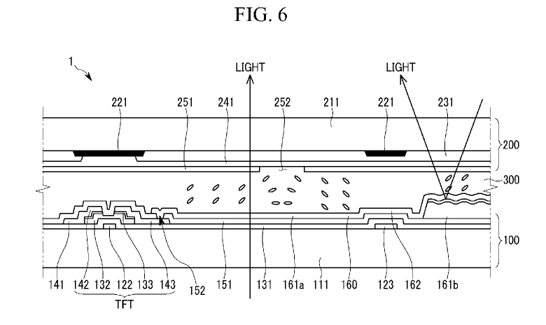

Hereinafter, an LCD according to a second exemplary embodiment of the present invention will be described with reference to FIG. 6. FIG. 6 is a cross-sectional view taken along line II-II in FIG. 1 and corresponds to FIG. 2. It should be noted that the following description will focus on features that are different from the first exemplary embodiment.

An organic layer 171 and a reflective metal layer 172 are disposed below a second sub-pixel electrode 161b. The organic layer 171 may include a photoresist polymer and with an embossed pattern on its surface. The reflective metal layer 172 on the organic layer 171 may have an embossed surface. The reflective metal layer 172 may be made of silver or aluminum with an excellent reflecting property.

Light from a backlight unit (not shown) disposed below a first substrate 100 enters a domain defined by a first sub-pixel electrode 161a and a domain defined by the second sub-pixel electrode 161b. The light entering the domain defined by the first sub-pixel electrode 161a exits to the outside via the first sub-pixel electrode 161a, a liquid crystal layer 300, and a second substrate 200, but the light entering the domain defined by the second sub-pixel electrode 161b is reflected on the reflective metal layer 172 to travel back toward the backlight unit.

On the other hand, light entering the reflective metal layer 172 from the outside is reflected on the reflective metal layer 172 to exit through the liquid crystal layer 300 and the second substrate 200.

As described above, the LCD 1 according to the second exemplary embodiment is a transflective type having a transmissive domain and a reflective domain. The transflective LCD ensures proper brightness according to environmental conditions so it may be particularly suitable for mobile electronic devices.

The descriptions of the openings 252, the area ratios of the openings 252 to sub-pixel electrodes 161a and 161b, and the distances between the openings 252 and the edges of the sub-pixel electrodes 161a and 161b, which were described in the first exemplary embodiment, are also applicable to the second exemplary embodiment. Accordingly, the LCD 1 according to the second exemplary embodiment may have reduced bruising.

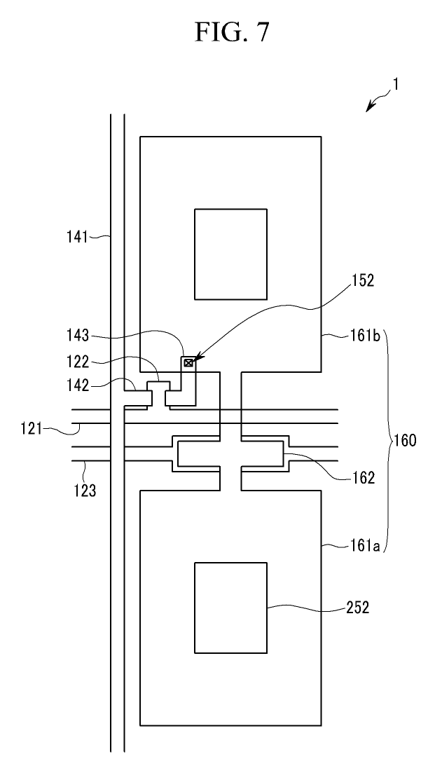

Hereinafter, an LCD according to a third exemplary embodiment of the present invention will be described with reference to FIG. 7. The description will focus on features that are different from the second exemplary embodiment.

A plurality of gate lines 121 are disposed between first sub-pixel electrodes 161a and second sub-pixel electrodes 161b. Each of a plurality of pixel electrodes 160 includes a first sub-pixel electrode 161a, a second sub-pixel electrode 161b, and a storage capacity forming part 162, which are formed integrally as in the first exemplary embodiment.

In the third exemplary embodiment, a distance between the sub-pixel electrodes 161a and 161b is increased because of the gate line 121 disposed between the first sub-pixel electrode 161a and the second sub-pixel electrode 161b. Accordingly, interference between domains defined by the sub-pixel electrodes 161a and 161b may be reduced to improve display quality.

The descriptions of the size of an opening 252, the area ratios of the opening 252 to sub-pixel electrode 161a or 161b, and the distances between the opening 252 and the edges of the sub-pixel electrodes 161a and 161b, which were described in the first exemplary embodiment, are also applicable to the third exemplary embodiment. Accordingly, the LCD 1 according to the third exemplary embodiment may have reduced bruising.

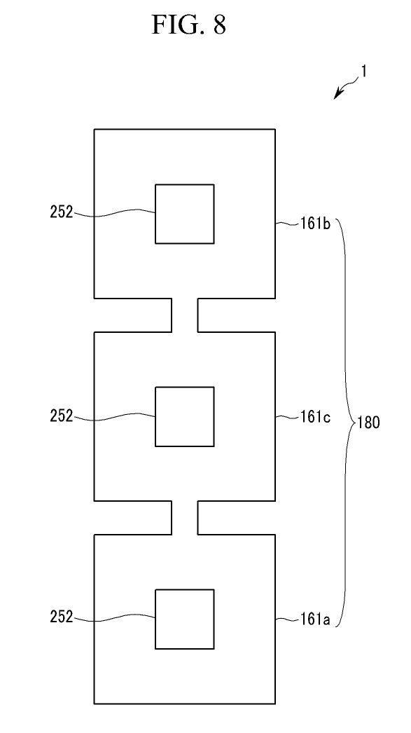

In the following, an LCD according to a fourth exemplary embodiment of the present invention will be described with reference to FIG. 8. FIG. 8 shows only a pixel electrode 180 and an opening 252.

A pixel electrode 180 includes three sub-pixel electrodes 161a, 161b, and 161c disposed lengthwise. Each sub-pixel electrode 161a, 161b, or 161c has a nearly square shape, and thus each corresponding opening 252 also has a nearly square shape.

According to the fourth exemplary embodiment, one pixel is divided into three domains, which may further improve visibility.

The descriptions of the size of the openings 252, the area ratios of the openings 252 to sub-pixel electrodes 161a and 161b, and the distances between the openings 252 and the edges of the sub-pixel electrodes 161a and 161b, which were described in the first exemplary embodiment, are also applicable to the fourth exemplary embodiment. Accordingly, the LCD 1 according to the fourth exemplary embodiment may have reduced bruising.

As described above, the present invention provides an LCD that may have reduced bruising.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display, comprising:
a first substrate comprising a pixel electrode having a plurality of sub-pixel electrodes, each sub-pixel electrode defining a domain;
a second substrate facing the first substrate and comprising a common electrode having openings corresponding to the sub-pixel electrodes; and
a liquid crystal layer disposed between the first substrate and the second substrate;
wherein each sub-pixel electrode has a rectangular shape, a maximum of minimum distances between sides of the opening and the corresponding sub-pixel electrode is in the range of about 5 μm to 20 μm, and an area ratio of the openings to the corresponding sub-pixel electrodes is in the range of about 0.12 to 0.2.

2. The liquid crystal display of claim 1, wherein the openings extend lengthwise and each of the openings has a width of about 14 μm or more.

3. The liquid crystal display of claim 2, wherein the sub-pixel electrodes and the openings each have the rectangular shape having a short side and a long side, and the long sides of the sub-pixel electrodes and the long sides of the openings are parallel with each other.

4. The liquid crystal display of claim 3, wherein each opening corresponds to a center area of a sub-pixel electrode.

5. The liquid crystal display of claim 2, wherein the pixel electrode has the rectangular shape having a short side and a long side, and the sub-pixel electrodes are disposed in one row along a direction of the long side of the pixel electrode.

6. The liquid crystal display of claim 5, wherein the pixel electrode comprises two sub-pixel electrodes.

7. The liquid crystal display of claim 6, wherein the first substrate further comprises a gate line disposed between the two sub-pixel electrodes.

8. The liquid crystal display device of claim 2, wherein the sub-pixel electrodes are integrally formed with each other.

9. The liquid crystal display of claim 2, wherein the liquid crystal layer is a vertically aligned mode liquid crystal layer.

10. The liquid crystal display of claim 2, the device have a resolution of about 120 ppi to 180 ppi, wherein the area ratio of the openings to the corresponding sub-pixel electrodes is in the range of about 0.14 to 0.2.

11. The liquid crystal display of claim 2, wherein at least one of domains defined by the sub-pixel electrodes has a reflective mode.

12. A liquid crystal display, comprising:
a first substrate comprising a pixel electrode having a plurality of sub-pixel electrodes, each sub-pixel electrode defining a domain;
a second substrate facing the first substrate and comprising a common electrode having openings corresponding to the sub-pixel electrodes; and
a liquid crystal layer disposed between the first substrate and the second substrate,
wherein a distance between one side of a sub-pixel electrode and one side of the corresponding opening, the one side of the sub-pixel electrode being parallel with the one side of the corresponding opening, is in the range of about 5 μm to 20 μm, and
wherein the opening extends lengthwise and has a width of about 14 μm or more.

13. The liquid crystal display of claim 12, wherein an area ratio of the openings to the corresponding sub-pixel electrodes is in the range of about 0.12 to 0.2.

14. The liquid crystal display of claim 13, wherein the liquid crystal layer is a vertically aligned mode liquid crystal layer, the sub-pixel electrodes and the openings each have a rectangular shape having a short side and a long side, the long sides of the sub-pixel electrodes and the long sides of the openings are parallel with each other, and each opening is disposed in a center area of the corresponding sub-pixel electrode.

15. A liquid crystal display, comprising:
a first substrate comprising a pixel electrode having a plurality of sub-pixel electrodes to define a domain;
a second substrate facing the first substrate and comprising a common electrode having an opening corresponding to each sub-pixel electrode; and
a liquid crystal layer disposed between the first substrate and the second substrate,
wherein an area ratio of the openings to the corresponding sub-pixel electrodes is in the range of about 0.12 to 0.2, and
wherein the openings extend lengthwise and have a width of about 14 μm or more.

16. The liquid crystal display of claim 15, wherein a distance between one side of the sub-pixel electrode and one side of a corresponding opening, the one side of the sub-pixel electrode being parallel with the one side of the corresponding opening, is in the range of about 5 μm to 20 μm.

17. The liquid crystal display of claim 16, wherein the liquid crystal layer is a vertically aligned mode liquid crystal layer, the sub-pixel electrodes and the openings each have a rectangular shape having a short side and a long side, the long sides of the sub-pixel electrodes and the long sides of the openings are parallel with each other, and each opening is disposed in a center area of the corresponding sub-pixel electrode.

18. The liquid crystal display of claim 15, wherein the sub-pixel electrodes and the openings each have a square shape.

19. The liquid crystal display of claim 2, further comprising a data line and a gate line crossing with each other, the data line extending lengthwise.

20. The liquid crystal display device of claim 1, wherein the opening corresponding to each sub-pixel electrode comprises a plurality of openings.
